(19) United States
(12) Patent Application Publication
(10) Pub. No.: US 2025/0051186 A1
(43) Pub. Date: Feb. 13, 2025

(54) APPARATUS AND METHOD FOR SEPARATING PARTICLES FROM WASTE FLUID USING OXYGEN ENRICHED AIR

(71) Applicant: DHI - DALBO HOLDINGS, INC. & SUBSIDIARIES, Salt Lake City, UT (US)

(72) Inventors: Gary J. COATES, The Woodlands, TX (US); Herron J. KENNEDY, Ocean Springs, MS (US)

(73) Assignee: DHI - DALBO HOLDINGS, INC. & SUBSIDIARIES, Salt Lake City, UT (US)

(21) Appl. No.: 18/232,606

(22) Filed: Aug. 10, 2023

(51) Int. Cl. C02F 1/24; C02F 3/02

(52) U.S. Cl. CPC C02F 1/24; C02F 3/025; C02F 2101/32

(57) ABSTRACT

A particle separation apparatus and method forms oxygen enriched air that contains an increased amount of oxygen and a decreased amount of nitrogen compared to ambient air, by passing air through at least one oxygen enriching membrane, introduces the oxygen enriched air into a fluid to form a fluid containing the oxygen enriched air, and uses the fluid containing the oxygen enriched air to generate microbubbles of the oxygen enriched air that float particulate matter in a waste fluid for separation from the waste fluid.

### BACKGROUND

Dissolved air flotation (DAF) is a fluid treatment process that removes suspended particles, such as oils, solids, and microorganisms, from wastewater or other fluids. DAF is commonly used in various industries, including wastewater treatment plants, oil refineries, food processing facilities, and paper mills, among others. DAF offers an efficient and reliable method for removing suspended solids and contaminants from a fluid. DAF utilizes the principle of flotation, where air is dissolved in a fluid such as water under pressure and then released in a flotation tank to create bubbles, typically microbubbles. The generated microbubbles attach to the suspended particles, causing them to rise to the surface for removal.

A typical DAF process may include the following steps:

1. Oxidation, Coagulation, and Flocculation: Chemical oxidants are added to the waste stream to kill bacteria and convert soluble metal species to insoluble forms such as the conversion of ferrous iron to the insoluble ferric hydroxide. Chemical coagulants are added to the waste stream to destabilize the particles and promote their aggregation into larger flocs. Flocculants such as polymers may also be added to enhance particle agglomeration.

2. Dissolved Air Generation: A dissolved air rich stream is formed, the concept being that the liquid to be treated, or a portion of it, is pressurized in the presence of ambient air and thus bringing the mixture in to equilibrium. The solubility of gases in liquids typically increases with an increase in pressure and/or decrease in temperature. Thus, pressuring and/or cooling the stream allows excess gas to be dissolved into the liquid versus ambient conditions.

3. Mixing and Contacting: The pressurized liquid containing dissolved air is introduced into a flotation tank or basin. At this point the pressure is released on the liquid and returns to ambient conditions, causing the gas to release from the liquid and forming the microbubbles.

4. Bubble Attachment: As the liquid flows through the flotation tank, the air microbubbles attach to the suspended particles present in the wastewater.

5. Particle Flotation: The microbubbles carrying the attached particles rise to the surface of the flotation tank, forming a froth or scum layer. The froth can be mechanically or hydraulically skimmed off to remove the floated particles from the tank.

6. Effluent Clarification: The clarified effluent, which is relatively free of suspended particles, is collected from the lower portion of the flotation tank. It can then undergo further treatment processes or be discharged as treated liquid, depending on the specific application.

7. Sludge Removal: The sludge or solids that accumulate at the surface of the flotation tank need to be periodically removed. This can be achieved by either manually scraping the sludge or using automated mechanisms such as skimmers or scrapers to continuously remove the floating solids.

Traditional DAF uses ambient air as the source for generating the microbubbles. Traditional DAF suffers from several practical deficiencies limiting its use in practice, for example such as being energy intensive to dissolve air into a liquid, requiring slow throughput rates to permit microbubbles to float particles to the surface, and requiring a large amount of pre-treatment chemicals including oxidants to be used in order to make the process effective.

### SUMMARY

The apparatus and method described herein addresses these and other issues, and thereby achieves an effective and efficient method for removing particulate matter from waste fluid such as wastewater.

The apparatus and method described herein economically enhances the effectiveness of traditional DAF systems. The subject matter includes use of a membrane process to create an oxygen enriched stream to supply the dissolved gas of the DAF. Following Henry's law, the solubility of oxygen is approximately two times greater than that of nitrogen in water, and by increasing the ratio of oxygen to nitrogen in the air, the amount of total dissolved gas will be proportionally increased in the system. Further, while generating dissolved air in a DAF system is an energy intensive process, use of oxygen enriched air will allow for a reduced amount of power consumption because the process will be more efficient at dissolving a fixed amount of gas per volume of fluid. An additional benefit is that by increasing the proportion of oxygen in the system, then the rate of oxidation in the process will be increased, thus allowing for reduced chemical oxidant demand in the process.

In embodiments, described is a particle separation apparatus comprising
a treatment region;
a waste fluid inlet configured to introduce waste fluid containing particulate matter into the treatment region;
an oxygen enrichment system comprised of
   an intake for ambient air, and
   at least one oxygen enriching membrane,
   wherein passing the air through the at least one oxygen enriching membrane increases an amount of oxygen and decreases an amount of nitrogen in the air to form oxygen enriched air;
a system configured to intake the oxygen enriched air and a fluid for the fluid containing oxygen enriched air, and to introduce the oxygen enriched air into the fluid, thereby forming the fluid containing oxygen enriched air;
a fluid feed region configured to produce microbubbles of oxygen enriched air from the fluid containing oxygen enriched air and provide the microbubbles for the treatment region; and
a collection device configured to collect the particulate matter floated to a surface of the waste fluid in the treatment region by the microbubbles.

In further embodiments, described is a method of separating particulate matter from waste fluid, the method comprising
forming oxygen enriched air that contains an increased amount of oxygen and a decreased amount of nitrogen compared to ambient air, by passing air through at least one oxygen enriching membrane;
introducing the oxygen enriched air into a fluid to form a fluid containing the oxygen enriched air;
introducing waste fluid containing particulate matter into a treatment region of an apparatus;
forming microbubbles of oxygen enriched air from the fluid containing the oxygen enriched air and providing the microbubbles to the treatment region, and wherein the microbubbles float the particulate matter in the waste fluid to a surface of the waste fluid in the treatment region; and
collecting the particulate matter from the surface of the waste fluid in the treatment region to thereby separate the particulate matter from the waste fluid.

### BRIEF DESCRIPTION OF THE DRAWINGS

FIG. 1 is a diagram of an oxygen enrichment system mounted to an exterior of a particle separation apparatus.

FIG. 2 is a side view of the particle separation apparatus.

FIG. 3 is a top view of the particle separation apparatus.

FIG. 4 is a diagram of an example fluid treatment process including dissolved air flotation (DAF).

FIG. 5 is a diagram of an example process for forming oxygen enriched air.

### DETAILED DESCRIPTION OF EXEMPLARY EMBODIMENTS

The apparatus and methods herein will be further described with reference to the drawing Figures, which are intended to be non-exclusive examples of the subject matter.

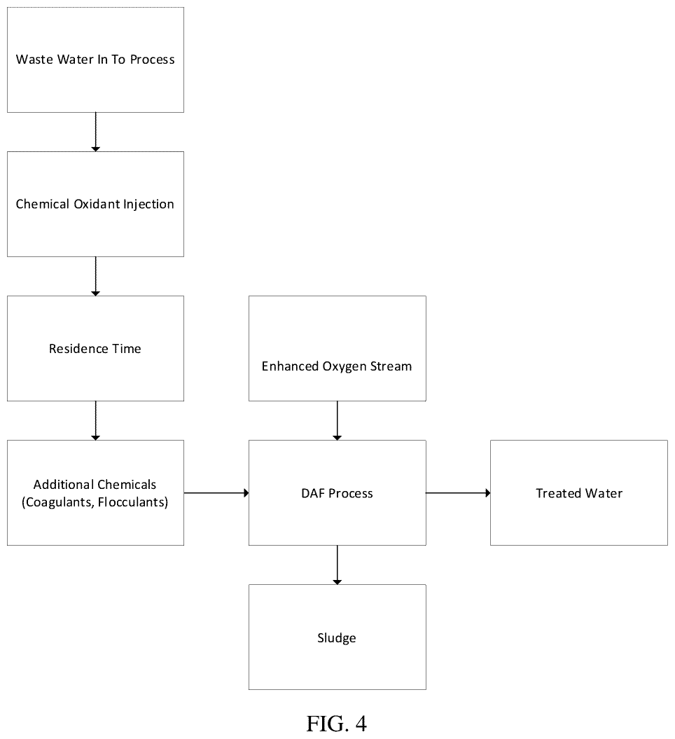

FIG. 4 illustrates an example fluid treatment method for wastewater contaminated with particulate matter such as oils, solids and microorganisms. While wastewater is exemplified in the method, the method may also be used with any other suitable fluid that needs to have particulate matter removed therefrom, such as fluids from various industries including wastewater treatment plants, oil refineries, food processing facilities, and paper mills.

In the illustrated method, the wastewater is subjected to optional pre-DAF processes including chemical oxidant treatment and additional chemical treatments with coagulants and/or flocculants. Chemical oxidants are added to the wastewater to kill bacteria and convert soluble metal species to insoluble forms such as the conversion of ferrous iron to the insoluble ferric hydroxide. Chemical coagulants are added to the wastewater to destabilize the particles and promote their aggregation into larger flocs, and flocculants such as polymers may be added to enhance particle agglomeration. The purpose of these pre-DAF treatments is to enhance the ability of the particulate matter in the wastewater to be removed by dissolved air flotation (DAF).

The chemical oxidant may be any suitable known oxidant, including as examples hydrogen peroxide, sodium hypochlorite, chlorine dioxide, sodium persulfates and permanganates. The coagulant may be any known coagulant, including an inorganic coagulant containing iron or aluminum, or an organic coagulant such as a polyamine or poly-DADMC (polydiallyldimethylammonium chloride). The flocculant may be any suitable flocculant for treating wastewater, such as any polyacrylamide based flocculant. A pH adjuster may also be added, as needed.

After addition of the chemical oxidant, the wastewater may be held for a residence time of from as short as 2 seconds to as long as 5 minutes, or even longer if necessary to ensure complete mixing of the oxidant in the wastewater and sufficient oxidation within the wastewater before further pre-treatments and the DAF treatment.

One of the several advantages of the apparatus and method described herein is that if a chemical oxidant is used in a pre-treatment, the amount used compared to a traditional method using DAF with ambient air may be able to be significantly reduced.

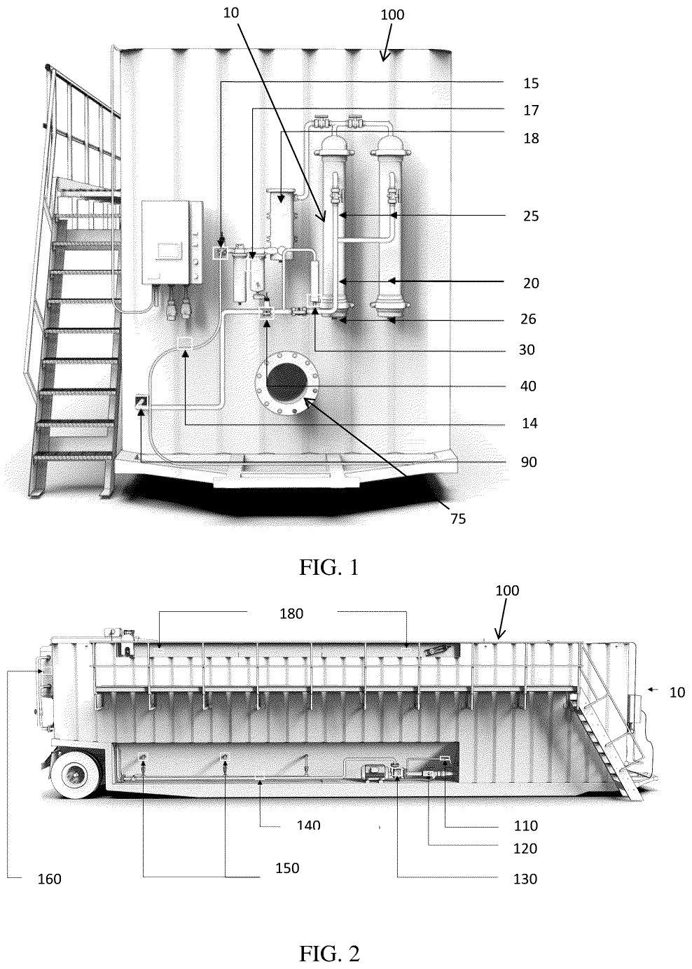

Upon completion of any pre-treatments, the wastewater is then fed into a particle separation apparatus 100 as shown in FIGS. 1-3, and in particular is fed via a wastewater inlet (not shown) into a treatment region 105, for example compartment and the like, of the apparatus 100. The treatment region may have any suitable size, particularly if the apparatus is a fixed installation, and can be fully enclosed or can be open, for example open by not have a top enclosing the top of the treatment region. In the case of a mobile apparatus, in which the apparatus may include wheels as shown in FIG. 2. The treatment region should have a size suitable for mobility and transport. In this case, the treatment region may have a capacity of, for example, 30,000 to 60,000 liters, such as 40,000 to 50,000 liters.

In the DAF process, oxygen enriched air is used as the agent to form microbubbles for use in the treatment region, the microbubbles attaching to the particulate matter within the wastewater and then carrying the attached particles to the surface of the wastewater in the treatment region, forming a froth or scum layer thereon. The froth can be mechanically or hydraulically skimmed off to remove the floated particles from the treatment region and transfer the removed particulate matter to a waste collection compartment 185, as will be described further below.

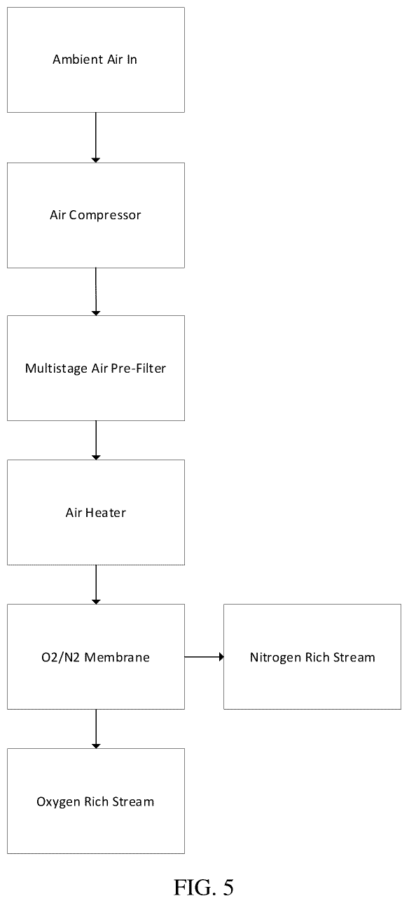

To provide the oxygen enriched air for the DAF process, a process such as shown in FIG. 5 may be used. In this process, ambient air is taken into the oxygen enrichment system 10, for example at an air intake. The ambient air is then preferably compressed by an air compressor, for example from 10 to 400 psi, such as 70 to 225 psi, and fed via line 14 into the oxygen enrichment system (for example, one or more devices) 10. As shown in FIG. 1, oxygen enrichment system 10 may have one or more, such as all, of the components of the system attached to an exterior wall of the apparatus 100. If desired, the system may alternatively be housed within an interior of the apparatus, could be skid mounted, or could be separate from (not mounted on or with) the apparatus 100.

The compressed air that is within line 14 is optionally flowed through an air regulator 15. The air regulator is used to control the pressure and flow rate of air through the oxygen enriching membranes 20. It may be desired that the compressed air is stored in a tank ahead of the oxygen enriching membranes 20 at a higher pressure than required by the process and thus needs to be down regulated. The compressed air may also optionally be fed through one or more air pretreatment devices such as an air filter 17, an air dryer 18 and a heater (not shown). The air filter prevents contaminates from entering the oxygen enriching membranes 20, which can be sensitive to plugging from particulates, water droplets, and oil. The treated air is preferably heated using a heater to a temperature above ambient temperature, for example to a temperature of from 35° C. to 100° C. such as 40° C. to 50° C. and then fed into one or more oxygen enriching membranes 20. The heater is used to increase the dew point of water and oil vapor to prevent it from condensing and plugging the membrane. The air regulator, air filter, air dryer and heater are all optional, but can serve to prolong the life of the oxygen enriching membranes, and is thus typically recommended. If more than one oxygen enriching membrane is used, the membranes may be used separately in parallel or together in series.

Each oxygen enriching membrane 20 is made up of, for example, hollow fiber membranes through which oxygen in the compressed ambient air passes at a higher rate than nitrogen in the compressed ambient air, thereby allowing the slower moving nitrogen to be separated and removed from the air. The membrane may be a commercially available membrane such as the PRISM® PA nitrogen membrane separator, which uses asymmetric hollow fiber membrane technology to separate and recover nitrogen from compressed air. Atmospheric air contains 78% nitrogen, 21% oxygen, and 1% other gases. The PRISM® PA membrane uses the principle of selective permeation to produce high-purity nitrogen. Each gas has a characteristic permeation rate, which is a function of its ability to dissolve and diffuse through a membrane. Oxygen is a “fast” gas and is selectively diffused through the membrane wall, while nitrogen is allowed to travel along the inside of the fiber, thus creating a nitrogen-rich product stream. The oxygen-enriched gas, or permeate, is vented from the membrane separator at atmospheric pressure. The driving force for the separation is the difference between the partial pressure of the gas on the inside of the hollow fiber and that on the outside. In the PRISM® PA membrane separator, compressed air flows down the inside of hollow fibers. Fast gases such as oxygen, carbon dioxide, and water vapor, and a small amount of slow gases, pass through the membrane wall to the outside of the fibers and exit the membrane at substantially atmospheric pressure. Most of the slow gases and a very small amount of the fast gases continue to travel through the fiber until they reach the end of the membrane separator, where the nitrogen rich gas exits the membrane. The removed nitrogen rich gas exits the membranes at nitrogen outlet 26, while the oxygen enriched air exits the membranes at outlet 25.

By “oxygen enriched air” herein is meant air that contains a higher amount of oxygen compared to the ambient air taken into the oxygen enrichment system. As an example, ambient air typically includes around 21% oxygen on a mole fraction basis. Following passing through the oxygen enriching membranes, the oxygen enriched air exiting the membranes at low pressure and has an oxygen content of at least 30% on a mole fraction basis, preferably 30% to 100% oxygen on a mole fraction basis. A single membrane may achieve an oxygen content of, for example, 30% to 75% oxygen on a mole fraction basis, such as 35%-50% oxygen on a mole fraction basis, whereas adding additional membranes in series can increase the oxygen percentage in the oxygen enriched air.

The oxygen enriched air outlets from the membranes are desirably fed to a single line 90 that includes a flow meter 30 and a pressure regulator 40. The oxygen enriched stream exiting the membrane is very close to ambient pressure as the higher the pressure gradient across the membrane then the greater throughput through the membrane. The pressure regulator is optional. Flow rates of oxygen enriched air may typically be from 3 SCFM to 8 SCFM, but this rate is not limited and is largely dependent on the fluid being processed and the rate at which pump 130 operates. The oxygen enriched air is fed by line 90 to pump 130 for dissolution into a fluid to form a fluid containing the oxygen enriched air.

The apparatus includes a system configured to intake a fluid for the fluid containing oxygen enriched air and also to intake the oxygen enriched air, and to introduce the oxygen enriched air into the fluid, thereby forming the fluid containing oxygen enriched air. The system thus forms the fluid containing oxygen enriched air, which will be introduced into the treatment region to form microbubbles therein.

An example of one such system is comprised of pump 130 that includes two feed lines. The first feed line is 90 containing the oxygen enriched air. The second feed line is for the fluid into which the oxygen enriched air is to be dissolved. The fluid is preferably the same kind of fluid that is being treated in the treatment region for removal of particulate matter therefrom. While the fluid may be fresh fluid, in a preferred embodiment, the fluid is fluid from treated fluid compartment 190 from which particulate matter has already been removed, thereby minimizing the need for introducing additional fresh fluid into the apparatus and system.

At pump 130, the fluid and oxygen enriched air are mixed and subjected to shear, thereby dissolving the oxygen enriched air in the fluid. In order to maximize the amount of oxygen enriched air in the fluid, the fluid may be cooled and/or pressurized, and is at least pressurized to enable formation of microbubbles of the oxygen enriched air later. The aerated fluid containing the oxygen enriched air may have a pressure of, for example, 50-200 psig, such as 75-100 psig. The air is typically introduced into the fluid at a rate of 1% to 15% by volume of the fluid, and possibly more depending on the temperature, pressure and mixing conditions in the pump. Aerated fluid containing the oxygen enriched air exits the pump 130 in line 140. Line 140 feeds one or more fluid inlets 150 configured to introduce the aerated fluid containing oxygen enriched air into the treatment region and to form microbubbles of the oxygen enriched air upon entry of the fluid into the treatment region. The aerated fluid may be controlled to have a flow rate of, for example, 25 gpm to 2,000 gpm or more, such as 100-1,000 gpm, or 150-200 gpm.

In an alternative system, the oxygen enriched air is injected into the fluid under pressure downstream of a pump in line 140. In such design, the pressurized injected air dissolves into the flowing fluid.

Once the fluid containing oxygen enriched air is formed, the fluid containing oxygen enriched air is provided to a fluid feed region. In this fluid feed region, microbubbles are formed from the oxygen enriched air in the fluid containing oxygen enriched air, and the formed microbubbles are provided to the treatment region in order to float the particulate matter to a surface of the waste fluid being treated in the treatment region of the apparatus.

In a first embodiment, the fluid feed region includes fluid inlets 150 that introduce the fluid containing oxygen enrich air into the treatment region via microbubble dispersion device. In this embodiment, each of the fluid inlets 150 is connected to and feeds the fluid containing oxygen enriched air, e.g., the aerated fluid, to a microbubble dispersion device, for example comprised of one or more dispersion tube(s) 155 each containing a number of nozzles or openings. The dispersion tube(s) 155 are located at a base of the treatment region, and may extend nearly an entire length or entire width of the treatment region. Any suitable number of dispersion tubes may be used, so long as an adequate number is provided to offer exposure of all of the particulate matter in the wastewater in the treatment region to microbubbles exiting the dispersion tube(s) 155.

When the aerated fluid enters the treatment region, the pressurization of the fluid is released, the pressure within the treatment region essentially being atmospheric pressure, which thereby releases the oxygen enriched air from the aerated fluid. The oxygen enriched air exits the fluid in the form of microbubbles. As previously explained, these microbubbles attach to particulate matter as they travel upwards through the wastewater in the treatment region, and deposit the collected particles at the surface of the wastewater in the treatment region.

In a second embodiment of the fluid feed region, the region may include a microbubble releasing mechanism such as a valve, orifice or any other device for creating a suitable pressure drop to release the oxygen rich air from the fluid, the microbubble releasing mechanism being located ahead of fluid inlets for the treatment chamber. In this embodiment, microbubbles are released from the fluid and formed in the fluid ahead of the fluid being introduced into the treatment region.

In an alternative arrangement of the apparatus to that described above, it is also possible to introduce the oxygen enriched air directly into the wasterwater prior to the wastewater being introduced into the treatment region, and thus use the wastewater itself as the fluid containing the oxygen enriched air. In this alternative embodiment, a system, which may be piping and/or a pump, is configured to intake the wastewater as well as and the oxygen enriched air, and to introduce the oxygen enriched air into the wastewater. The wastewater containing oxygen enriched air is then subjected to pressure relief, either ahead of entry into the treatment region or at the time of entry into the treatment region, in order to release microbubbles of the oxygen enriched air into the wastewater. As a result, particulate matter in the wastewater is floated to a surface of the wastewater in the treatment region as in the arrangement described above.

If necessary, an excess air separator 160 may be included in the apparatus in order to remove excess air from the aerated fluid. When more air is fed to pump 130 than can be dissolved into the fluid, the excess air separator can prevent bulk air from entering the treatment region through the nozzles. However, overfeeding the pump slightly with oxygen enriched air is preferable to achieve maximum saturation.

The residence time of the wastewater within the treatment region is preferably short in order to permit larger volumes of wastewater to be treated. In a treatment region of 40,000 to 50,000 liters, the wastewater may have a residence time within the treatment region of, for example, 2 to 20 minutes, preferably 5-15 minutes, more preferably 5-10 minutes. The treatment in the apparatus is thus preferably a continuous process in which treated wastewater is removed from the treatment region, for example at one or more outlets located at a base of the treatment region so as to avoid any particulate matter being reintroduced into the treated water being removed from the treatment region. The removed treated water may be transferred to an optional treated water compartment 190, with a weir or similar device 195 located therein in order to control water level and flow rates through the apparatus. The treated water may also be directly removed from the treatment region to a pipe for use or disposal.

As noted above, a portion of the treated water in the treated water compartment may be used to feed fluid for aeration to pump 130. The remainder of the treated water may be removed from the apparatus 100 via outlet 75 and used in other processes or disposed of. As an example, in hydraulic fracturing operations, the treated water is stored for use in hydraulic fracturing of other wells.

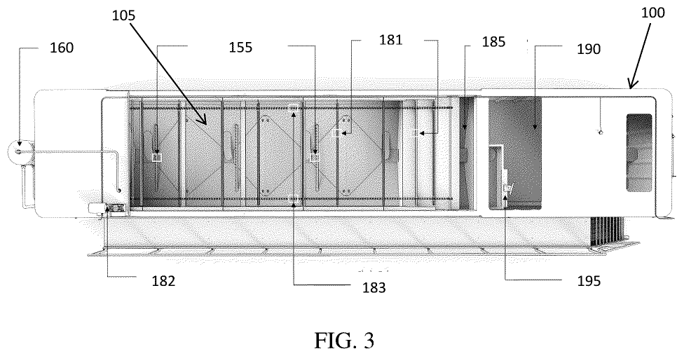

To remove the collected particulate matter from the surface of the wastewater in the treatment region, any suitable collection device 180 for removing particles at the surface of a fluid may be used. In the embodiment shown in FIG. 3, the collection device 180 is a skimmer comprised of paddles that are pulled across the surface of the wastewater in the treatment region by a chain system 183 or the like driven by a motor and gear system 182. The paddles move the froth of particulate matter toward a waste collection compartment 185 within the apparatus, where the froth is deposited off of the paddles. The sludge or waste collected in the waste collection compartment 185 is removed, either continuously or intermittently, and disposed of properly.

The apparatus may also include an additional collection region at the base of the treatment region in order to remove therefrom heavier waste solids that settle to the bottom of the chamber rather than float to the surface of the wastewater in the treatment region.

The apparatus and method, and the benefits thereof, will be further illustrated by way of the following prophetic example and comparative example.

The comparative example is a traditional DAF system using ambient air as the microbubble source.

A standard DAF treating oilfield-produced water is operated at a continuous throughput of 1600 gpm. As part of the operation, hydrogen peroxide is injected into the process as a chemical oxidant ahead of the DAF to kill bacteria and to remove dissolved iron in the water. For this particular water, 50 ppm of hydrogen peroxide is required to meet the required KPI's of the treated water stream. Downstream of the oxidant injection, poly aluminum chloride coagulant and an anionic high molecular weight polyacrylamide flocculant are injected before the water eventually reaches the DAF unit. The DAF unit has a 45,000 liter flotation tank treatment region, with 7.5 minutes of residence time in the process where lightweight solids are floated to the surface for skimming and heavier solids settle to the bottom of the tank. The cleaned process water exits the DAF unit at approximately the same rate as it enters. The separated solids are stored for further processing and/or disposal.

As part of the DAF process, a recycle stream of the cleaned treated water is used to generate dissolved air in and then reintroduced into the flotation chamber at various injection points. The recycle stream operates at a pressure of 100 psig and a flow rate of 200 gpm. The process conditions are such that 3.54 cubic feet of air at ambient temperature and pressure are required to be supplied to the inlet side of multistage pump to achieve the desired gas saturation of the liquid stream. The ambient air makeup is a standard 78% nitrogen, 21% oxygen, and 1% other gases. The air is supplied to the inlet side of the pump via tubing from an air flow meter with a valve to throttle air through the meter entering directly from the atmosphere under suction generated by the pump.

In addition to the advantages already discussed above, the present method and apparatus has additional advantages. For example, use of oxygen enriched air is able to oxidize and capture suspended solids more rapidly, and thus enhances separation of the solids from the wasterwater. As a result, it is also possible to use smaller pumps, if desired, compared to using ambient air, thereby reducing power consumption in the process.

The following example illustrates the inventive subject matter, with oxygen enriched air used to generate microbubbles for the DAF.

A membrane enhanced DAF treating oilfield-produced water is operated at a continuous throughput of 1600 gpm. As part of the operation, hydrogen peroxide is injected into the process ahead of the DAF to kill bacteria and to remove dissolved iron in the water. For this particular water, 50 ppm of hydrogen peroxide would normally be required to meet the required KPI's of the treated water stream. However, by utilizing a membrane to supply an oxygen enriched stream to the DAF, the hydrogen peroxide demand is reduced to 40 ppm. Downstream of the oxidant injection, poly aluminum chloride coagulant and an anionic high molecular weight polyacrylamide flocculant are injected before the water eventually reaches the DAF unit. The DAF unit is the same as described above for the comparative example.

As part of the membrane enhanced DAF process, a recycle stream of the cleaned treated water is used to generate oxygen enriched dissolved gas in and then reintroduced into the flotation treatment region at various injection points. The recycle stream operates at a pressure of 100 psig and a flow rate of 200 gpm. The process conditions are the same as the comparative example and such that 4.17 cubic feet of oxygen enriched air at ambient temperature and pressure are supplied to the inlet side of multistage pump to achieve the equivalent saturation percentage of the liquid stream, representing a 17.8% increase in total dissolved gas and a 90.5% increase in dissolved oxygen. The oxygen enriched air makeup supplied from the membrane is 59% nitrogen, 40% oxygen, and 1% other gases. The oxygen enriched air is supplied to the inlet side of the pump via tubing from an air flow meter with a valve to throttle air through the meter entering from the membrane process.

Although specific embodiments have been described herein, the scope of the claimed subject matter is not limited to those specific embodiments. The scope of the claimed subject matter is defined by the following claims and any equivalents therein. As will be appreciated by one skilled in the art, aspects of the present disclosure may be embodied as an apparatus, system or method.

The Figures illustrate the architecture, functionality, and operation of possible implementations of apparatuses and methods according to various embodiments of the present disclosure. In this regard, each block or feature in the Figures may represent a module, segment, or portion of the method or apparatus, and the functions noted therein may occur out of the order noted in the Figures. For example, two blocks or features shown in succession may, in fact, be executed substantially concurrently, or the blocks or features may sometimes be executed in the reverse order, depending upon the functionality involved.

What is claimed is:

1. A particle separation apparatus comprising:
a treatment region;
a waste fluid inlet configured to introduce waste fluid containing particulate matter into the treatment region;
an oxygen enrichment system comprised of
an intake for taking in ambient air, and
at least one oxygen enriching membrane,
wherein passing the air through the at least one oxygen enriching membrane increases an amount of oxygen and decreases an amount of nitrogen in the air to form oxygen enriched air;
a system configured to intake the oxygen enriched air and a fluid for the fluid containing oxygen enriched air, and to introduce the oxygen enriched air into the fluid, thereby forming the fluid containing oxygen enriched air;
a fluid feed region configured to produce microbubbles of oxygen enriched air from the fluid containing oxygen enriched air and provide the microbubbles for use in the treatment region; and
a collection device configured to collect the particulate matter floated to a surface of the waste fluid in the treatment region by the microbubbles.

2. The particle separation apparatus according to claim 1, wherein the ambient air taken in is compressed by an air compressor prior to being fed to the oxygen enrichment system.

3. The particle separation apparatus according to claim 1, wherein the oxygen enrichment system further includes at least one air pretreatment device selected from the group consisting of a heater, an air filter and an air dryer.

4. The particle separation apparatus according to claim 1, wherein the oxygen enrichment system includes an outlet for nitrogen removal.

5. The particle separation apparatus according to claim 1, wherein the at least one oxygen enriching membrane comprises hollow fiber membranes that oxygen passes through more rapidly than nitrogen, thereby permitting removal of nitrogen and increasing an amount of oxygen in the air.

6. The particle separation apparatus according to claim 1, wherein the oxygen enriched air contains 30% to 75% oxygen on a mole fraction basis.

7. The particle separation apparatus according to claim 1, wherein the fluid feed region includes at least one fluid inlet connected to a microbubble dispersion device with openings located at a base of the treatment region.

8. The particle separation apparatus according to claim 1, wherein the fluid feed region includes a microbubble releasing mechanism ahead of a fluid inlet into the treatment region, wherein passing the fluid containing oxygen enriched air through the microbubble releasing mechanism forms the microbubbles in the fluid.

9. The particle separation apparatus according to claim 1, wherein the fluid containing oxygen enriched air is under pressure above atmospheric, and the treatment region is substantially at ambient pressure.

10. The particle separation apparatus according to claim 1, wherein the collection device is comprised of one or more movable paddles configured to move across the surface of the waste fluid in treatment region.

11. The particle separation apparatus according to claim 1, wherein the collection device deposits collected particulate matter from the surface of the waste fluid in the treatment region in a waste collection compartment separate from the treatment region.

12. The particle separation apparatus according to claim 1, wherein the apparatus further includes a treated fluid compartment that receives, from the treatment region, treated fluid from which particulate matter has been removed.

13. The particle separation apparatus according to claim 12, wherein the fluid containing oxygen enriched air is comprised of treated fluid from the treated fluid compartment.

14. The particle separation apparatus according to claim 1, wherein the system configured to intake the oxygen enriched air and the fluid for the fluid containing oxygen enriched air includes a pump that receives both the fluid and the oxygen enriched air and provides shear to introduce the oxygen enriched air into the fluid.

15. The particle separation apparatus according to claim 1, wherein the apparatus is mobile and includes wheels attached thereto.

16. The particle separation apparatus according to claim 1, wherein the particulate matter includes one or more of oils, solids, and microorganisms.

17. The particle separation apparatus according to claim 1, wherein the waste fluid comprises wastewater.

18. A particle separation apparatus comprising:
a treatment region;
a waste fluid inlet configured to introduce waste fluid containing particulate matter and oxygen enriched air and/or microbubbles of the oxygen enriched air into the treatment region;
an oxygen enrichment system comprised of
an intake for taking in ambient air, and
at least one oxygen enriching membrane,
wherein passing the air through the at least one oxygen enriching membrane increases an amount of oxygen and decreases an amount of nitrogen in the air to form oxygen enriched air;
a system configured to intake the waste fluid and the oxygen enriched air, and to introduce the oxygen enriched air into the waste fluid; and
a collection device configured to collect the particulate matter from the waste fluid that is floated to a surface of the waste fluid in the treatment region by the microbubbles formed from the oxygen enriched air.

19. A method of separating particulate matter from waste fluid, the method comprising
forming oxygen enriched air that contains an increased amount of oxygen and a decreased amount of nitrogen compared to ambient air, by passing air through at least one oxygen enriching membrane;
introducing the oxygen enriched air into a fluid to form a fluid containing the oxygen enriched air;
introducing waste fluid containing particulate matter into a treatment region;
forming microbubbles of oxygen enriched air from the fluid containing the oxygen enriched air and providing the microbubbles to the treatment region, and wherein the microbubbles float the particulate matter in the waste fluid to a surface of the waste fluid in the treatment region; and
collecting the particulate matter from the surface of the waste fluid in the treatment region to thereby separate the particulate matter from the waste fluid.

20. The method according to claim 19, wherein the method further comprises collecting treated fluid, from which the particulate matter has been removed, from the treatment region, and using at least a portion of the treated fluid to form the fluid containing oxygen enriched air.

21. The method according to claim 19, wherein collecting the particulate matter comprises moving one or more paddles across the surface of the waste fluid in the treatment region, and depositing the collected particulate matter into a waste collection compartment separate from the treatment region.

22. The method according to claim 19, the method further comprising making the pressure of the fluid containing oxygen enriched air greater than atmospheric pressure.

23. The method according to claim 19, wherein the method further comprises introducing a chemical oxidant into the waste fluid prior to introduction of the waste fluid containing oxygen enriched air into the treatment region.

24. The method according to claim 23, wherein an amount of the chemical oxidant introduced is lower than amount that would be required to be used if using ambient air instead of oxygen enriched air to form the microbubbles.

25. The method according to claim 19, wherein the oxygen enriched air is introduced into the waste fluid prior to introducing the waste fluid into the treatment region, such that the fluid containing the oxygen enriched air is the waste fluid.
